(19) United States
(12) Patent Application Publication
(10) Pub. No.: US 2015/0370147 A1
(43) Pub. Date: Dec. 24, 2015

(54) FLASHLIGHT

(71) Applicant: Qingyuan Chen, Leqing City (CN)

(72) Inventor: Qingyuan Chen, Leqing City (CN)

(73) Assignee: Yueqing Chuangyi Photography Equipment Co., Ltd.

(21) Appl. No.: 14/616,343

(22) Filed: Feb. 6, 2015

(30) Foreign Application Priority Data
Jun. 23, 2014 (CN) 201410283248.3

(51) Int. Cl. G03B 17/06; G03B 17/18; G03B 15/05

(52) U.S. Cl. CPC G03B 17/06; G03B 15/05; G03B 17/18

(57) ABSTRACT

The present invention provides a flashlight, comprising: an input module, configured to input a first input information, the first input information is used to trigger the first main control module to adjust the output mode of the flashlight and the output mode is an output mode comprising flashlight parameters and parameter names; a first main control module connected to the input module, configured to receive the first input information, determine the output mode of the flashlight corresponding to the first input information, and generate a first control instruction corresponding to the output mode; a display connected to the first main control module, configured to receive the first control instruction, and output the flashlight parameters and parameter names according to the first control instruction. Since the flashlight provided in the present invention can not only display values of the parameters but also names of the parameters, users can readily and directly appreciate what the indicated parameters mean according to the full names of parameters without having to review the specification or user manual, thereby facilitating the ease-of-use and promoting wide application of the flashlight.

### TECHNICAL FIELD

The present invention relates to the technical field of flashlight, and in particular to a flashlight.

### BACKGROUND ART

Flashlight is an artificial light source used in photography. When the shutter of a camera is pressed down, the flashlight usually lights the scene within 1/10000 seconds to 1/20 seconds. However, with the development of digital technology and the popularity of photography, hot shoe-style flashlight has been widely used in photography as it can provide with a more professional flashing effect.

Before photographing via a hot shoe-style flashlight, one must first set the parameters of the flashlight such as its working status, to produce various photographic effects in different light conditions via the adjustment of flashlight parameters. However, as shown in FIG. 1, during the setting of parameters of the existing flashlights, only the value or symbol of the corresponding parameter is displayed. For a number of users, they may understand the meaning represented by the value or the symbol only after reviewing the specification. Therefore, users may not readily understand the visual information of those parameters they need to set, which tremendously limits the conventional use of flashlights today.

### SUMMARY OF THE INVENTION

The present invention provides a flashlight to solve the above issues, i.e., flashlights in prior art only display value or symbol of the corresponding parameter which affects the understanding of users.

In order to overcome the current limitations posed in the above, the present invention provides the following solutions:

A flashlight can include an input module, configured to receive a first input information. The first input information is used to trigger a first main control module to adjust output mode of the flashlight, and the output mode generates flashlight parameters and parameter names.

The first main control module is connected to the input module, configured to receive the first input information, determine the output mode of the flashlight corresponding to the first input information, and generate a first control instruction corresponding to the output mode.

The display is connected to the first main control module, configured to receive the first control instruction, and output the flashlight parameters and parameter names according to the first control instruction.

Preferably, the input module is also used to receive a second, alternative input information. The second input information is used to trigger the first main control module to adjust the display mode of the flashlight. The display mode refers to a mode of displaying flashlight parameters in a certain language and color.

The first main control module is also used to receive the second input information, determine the display mode of the flashlight corresponding to the second input information, and generate a second control instruction corresponding to the display mode;

The display is also used to receive the second control instruction, and output the display language and color of the flashlight parameters according to the second control instruction. The display can be a color display.

Preferably, the parameters can include flashing mode, power, flashing times, focal length or frequency. The flashing mode can include Through The Lens (TTL) mode, manual mode, repetition mode, wireless mode and custom mode.

Preferably, the flashlight can also include a stepper motor, a voltage-stabilizing circuit and a voltage boosting and stabilizing charging circuit connected to the first main control module.

Preferably, the flashlight can further include a power source connected to the voltage-stabilizing circuit, the voltage boosting and stabilizing charging circuit and the first main control module.

Preferably, the flashlight can also include a capacitor connected to the first main control module and the voltage boosting and stabilizing charging circuit.

Preferably, the flashlight can further include a second main control module connected to the first main control module.

Preferably, the first main control module and the second main control module are connected via synchronous/asynchronous serial receiver/transmitter.

Preferably, the flashlight can further include a wireless instruction receiving module, a camera hot shoe connector, a light sensor module and a trigger circuit connected to the second main control module, in which the trigger circuit is connected to the flashlight tube for controlling the on or off function of the flashlight tube.

Preferably, the flashlight can further include a high temperature monitoring module connected to the first main control module and a buzzer alarm module connected to the second main control module.

Compared with current state of the art, the technical solutions provided in the present invention have the following merits:

For the flashlight provided in the present invention, after the input module inputs the first input information, the first main control module determines output mode of the flashlight according to the first input information, and generates a corresponding first control instruction; the display outputs the flashlight parameters and parameter names according to the first control instruction. Since the flashlight provided in the present invention can not only display values of the parameters but also full names of the parameters, users can readily and directly appreciate what the indicated parameters mean according to the full parameter names and descriptions without having to review the specification or manuals, thereby facilitating the ease-of-use and promoting wide application of the flashlight.

### DESCRIPTION OF THE DRAWINGS

In order to better illustrate technical solutions in embodiments of the present invention or in prior art, accompanying drawings representing the different embodiments as described in the specification are provided. As can be seen, however, the drawings illustrated below are only embodiments of the present invention. Other drawings may also be obtained by person of ordinary skill in the art according to the drawings provided without exerting undue creative effort.

FIG. 1 is a schematic of display mode of flashlight in prior art;

FIG. 2 is a structural schematic of a flashlight in one embodiment of the present invention;

FIG. 3 is a schematic of a display mode of a flashlight in one embodiment of the present invention;

FIG. 4A, 4B are schematics of display mode of the TTL mode of a flashlight according to one embodiment of the present invention, respectively displayed in Chinese and English language option;

FIG. 5A, 5B are schematics of display mode of manual mode of a flashlight according to one embodiment of the present invention, respectively displayed in Chinese and English language option;

FIG. 6A, 6B are schematics of display mode of repetition mode of a flashlight according to one embodiment of the present invention, respectively displayed in Chinese and English language option;

FIG. 7A, 7B are schematics of display mode of wireless mode of a flashlight according to one embodiment of the present invention, respectively displayed in Chinese and English language option;

FIG. 8A, 8D are schematics of display mode of custom mode of a flashlight according to one embodiment of the present invention, respectively displayed in Chinese and English language option.

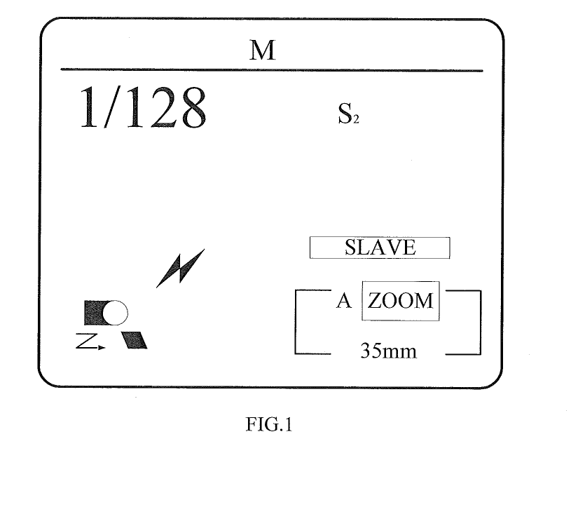

### DETAILED DESCRIPTION OF THE INVENTION

Hereinafter, technical solution in embodiments of the present invention will be fully described, taken in conjunction with the drawings in the embodiments of the present invention. As can be seen, the embodiments illustrated are only a part of all possible embodiments of the present invention. Based on the embodiments of the present invention, all other embodiments that can be practiced by persons of ordinary skill in the art without exerting undue creative effort shall fall within the protective scope of the present invention

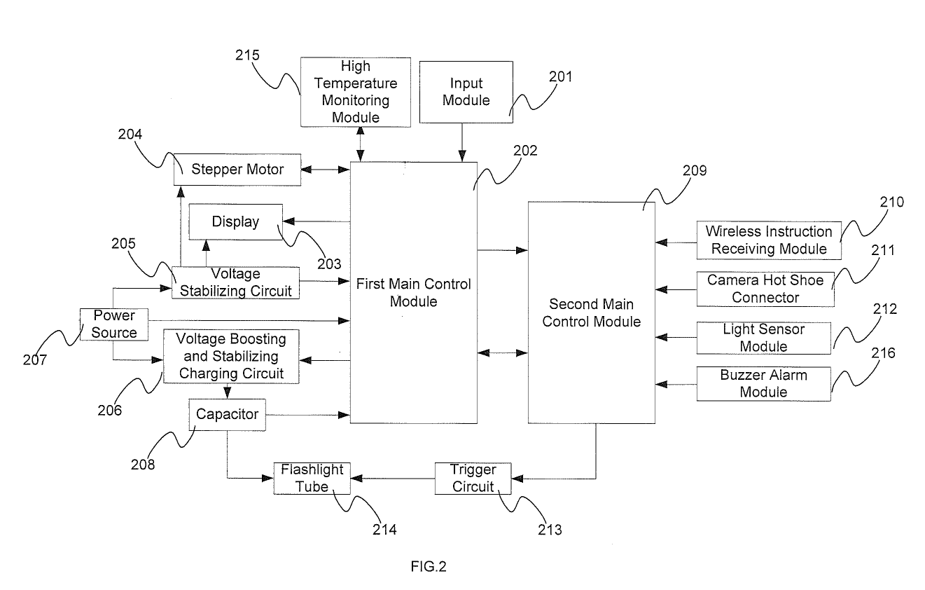

According to one embodiment of the present invention, there is provided a flashlight. As shown in FIG. 2, the flashlight includes an input module 201, a first main control module 202 connected to the input module 201, a display 203 connected to the first main control module 202. Wherein, the input module 201 is a keypad circuit, through which different information may be input via pressing different keypads; the display 203 is color display, preferably color liquid crystal display.

The input module 201 is used to input a first input information. The first input information is used to trigger the first main control module 202 to adjust output mode of the flashlight; the output mode of the flashlight is an output mode comprising flashlight parameters and parameter names; the first main control module 202 is used to receive the first input information, determine output mode of the flashlight corresponding to the first input information, and generate a first control instruction corresponding to the output mode; the display 203 is used to receive the first control instruction, and output the flashlight parameters and parameter names according to the first control instruction.

In addition, the input module 201 is also used to receive a second input information; the second input information is used to trigger the first main control module 202 to adjust display mode of the flashlight; the display mode is a display mode comprising display language and color of the flashlight parameters; the first main control module 202 is also used to receive the second input information, determine display mode of the flashlight corresponding to the second input information, and generate a second control instruction corresponding to the display mode; the display 203 is also used to receive the second control instruction, and output display language and color of the flashlight parameters according to the second control instruction.

In the present embodiment, the display 203 has multiple display zones, with different display zones display different parameters and their names. Wherein, the parameters displayed in different output mode are different, and the corresponding display zones are different as well.

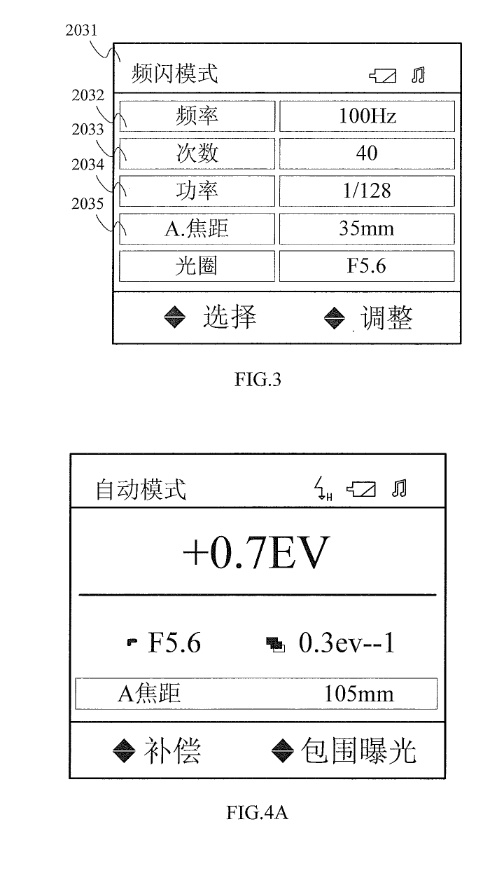

As shown in FIG. 3, taking the Chinese display interface of repetition mode as an example, the display zone 2031 displays name of the flashing mode of the flashlight, the display zone 2032 displays value and name of the frequency corresponding to the flashing mode, the display zone 2033 displays value and name of times, the display zone 2034 displays value and name of power, and the display zone 2035 displays value and name of focal length. As such, users can directly understand the meaning of the parameters by referring to their names, which will help the users set those parameters.

In different display modes, the color of different display zones of the display 203 may be different, and the language of the parameters displayed may be different as well. Different languages can be made available, such as Chinese, English, Portuguese or Spanish. Since different display zones correspond to different colors, colors of different display zones may be set and combined in any ways so that the flexibility in the design of the display interface of display 203 may be improved and the colors of the display interface may be enriched. For example, the display zone 2031 and the display zone 2032 may have different colors. For instance, the display zone 2031 is orange and the display zone 2032 is yellow; or the display zone 2033 and the display zone 2034 may have the same color; for instance, the display zone 2033 and the display zone 2034 are both in light blue.

As shown in FIG. 2, in addition to the input module 201, the first main control module 202 and the display 203, the flashlight provided in the present embodiment can also include a stepper motor 204, a voltage-stabilizing circuit 205 and a voltage boosting and stabilizing charging circuit 206 connected to the first main control module 202; and a power source 207 connected to the voltage-stabilizing circuit 205 and the voltage boosting and stabilizing charging circuit 206 and the first main control module 202, wherein, the power source 207 may be a 6 V battery, and may also be a mains electricity power source, used for supplying voltage for the first main control module 202 and so on; and a capacitor 208 connected to the first main control module 202 and the voltage boosting and stabilizing charging circuit, wherein the first main control module 202 determines whether the voltage of the capacitor 208 is relatively low according to the feedback voltage from the capacitor 208, and supplies power to the capacitor 208 when the voltage of the capacitor 208 is relatively low and trigger the capacitor to store power.

In the present embodiment, the first main control module 202 realize the input, display and control of signals via the connected input circuit 201, display 203 and voltage-stabilizing circuit 205. In addition, the flashlight of the present embodiment can also include a second main control module 209 connected to the first main control module 202. The flashlight may be triggered and its communication with the camera may be realized via the wireless instruction receiving module 210, the camera hot shoe connector 211, the light sensor module 212, the trigger circuit 213, and the like, connected to the second main control, module 209. The trigger circuit 213 can be connected to the flashlight tube 214 to control the on or off function of the flashlight tube 214.

Preferably, the first main control module 202 and the second main control module 209 are connected via USART (Universal Synchronous/Asynchronous Receiver/Transmitter), thus realizing synchronous interaction of information between the first main control module 202 and the second main control module 209. Compared with the conventional flashlight in the art which only adopts one main control module, the flashlight in the present embodiment adopts two main control modules, which increases the processing speed and shortens the response time of the flashlight tube.

In addition, the first main control module 202 is also connected to a high temperature monitoring module 215 to monitor temperature of the first main control module so as to prevent any deleterious effect on the performance of the flashlight caused by over-heating of the first main control module due to high temperature; the second main control module 209 is also connected to the a buzzer alarm module 216 to trigger an alarm when the flashlight is in an abnormal working condition.

Parameters of the flashlight provided in the present embodiment can include flashing mode, power, flashing times, focal length or frequency and the like, in which the flashing mode can include TTL (Through The Lens) mode, manual mode, repetition mode, wireless mode and custom mode. Moreover, the flashing mode and names of relevant parameters in the present embodiment may be displayed in various languages, including Chinese, English, Portuguese and Spanish. In the present invention, the display mode of the display 203 is illustrated using two of the available language options, namely Chinese and English languages as examples.

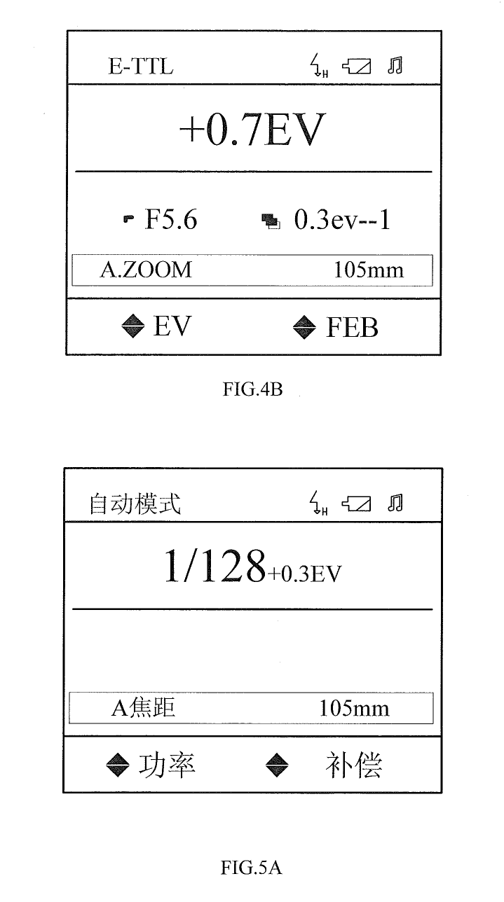

The Chinese and English display modes of the TTL mode are shown in FIG. 4A and FIG. 4B respectively. Different display zones display different values and their corresponding parameter names so that users can readily understand the meaning of those values. For those beginners and amateurs, the TTL mode is the safest and most convenient mode in complicated environments. In this mode, users can obtain desired photographic effect through simple adjustments of the parameters. In the TTL auto mode, the flashlight will pre-flash once and automatically provide an output value after combining information such as exposure control and focal length obtained after the pre-flash. That is to say, in the auto mode, users can set various parameters of the camera according to their personal practical needs regardless of the output value of the flashlight.

The Chinese and English display options of the manual mode are shown in FIG. 5A and FIG. 5B respectively. When manual exposure is needed, the flashlight may be changed into manual mode, namely M mode, to manually adjust the focal length and thus the requirement of individual users may be satisfied. In this mode, the flashlight can match the camera's rate to continuously shoot at a high speed, and can also select different exposure output.

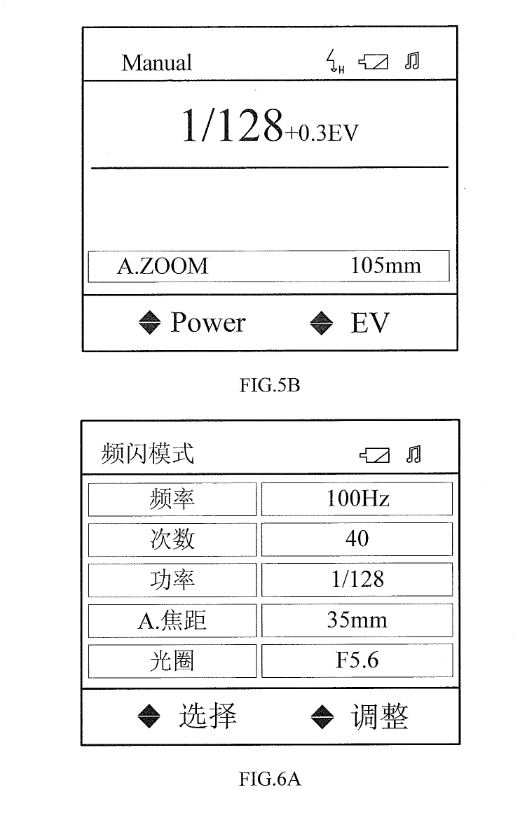

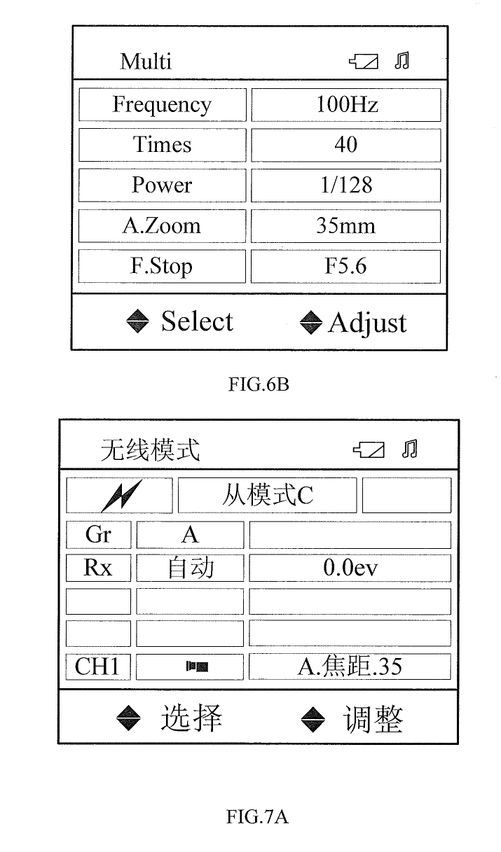

The Chinese and English display options for the repetition mode or the Multi mode are shown in FIG. 6A and FIG. 6B respectively. After the Multi mode is selected, the flashing times/repetitions, flashing frequency and output value can be adjusted respectively.

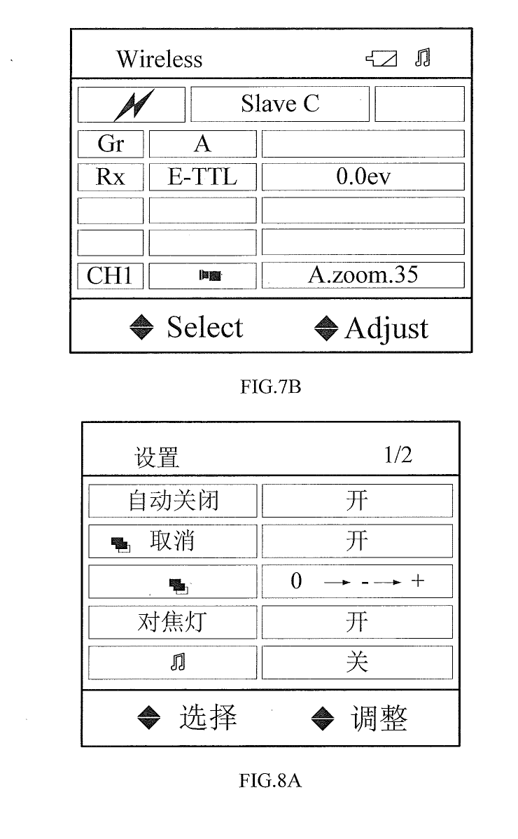

The Chinese and English display options for the wireless mode are shown in FIG. 7A and FIG. 7B respectively. The flashlight provided in the present embodiment may receive wireless signals of main control modes from the built-in flashlight or hot shoe flashlight of a camera, thereby allowing off-the-camera creative flashing.

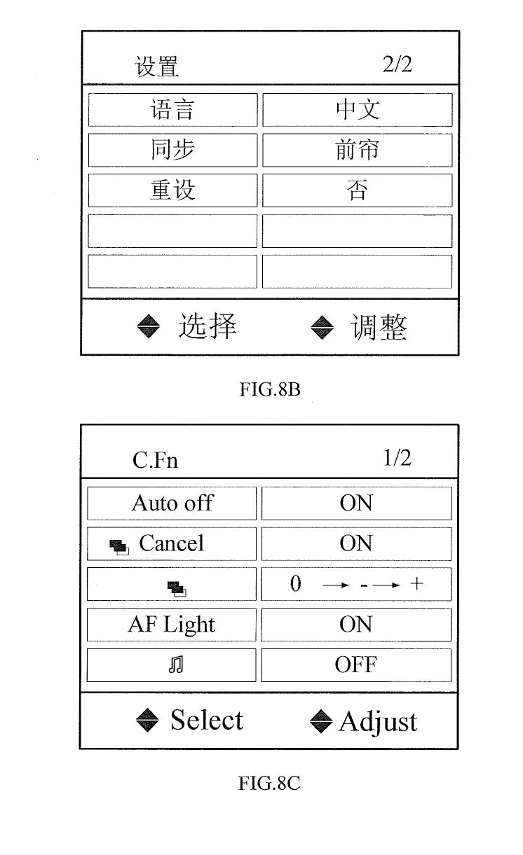

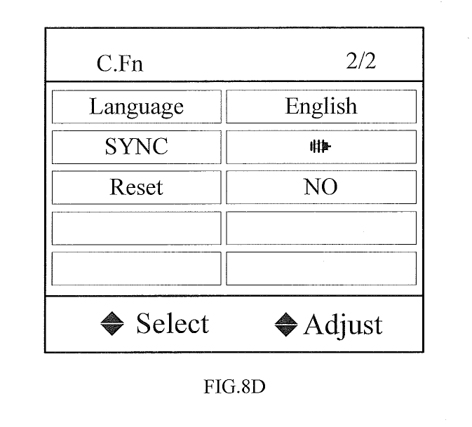

Alternatively, the flashlight is also provided with a custom mode for setting custom function and language display and the like of the flashlight, wherein the Chinese and English display modes/options are shown in FIG. 8A-8D respectively.

In the display mode as described above, what the flashlight displays are the full names (descriptions) of the parameters in English. Although English abbreviations can also be used to represent or illustrate the meaning of the parameters, it is generally known that the same English abbreviation may not bear a unique meaning. For example, EV may be the English abbreviation of Exposure-Value, but may also be the English abbreviation of Electron-Volt, the unit of energy used in the non-international unit system. Therefore, users may not readily and directly determine the meaning of the parameters according to their English abbreviations. They still need to review the specification, which can frustrate rather than help to expand the utilization and application of flashlights by the general public. However, in other embodiments of the present invention, when the display language of the flashlight is in another language, Portuguese for example, the users can adjust the camera to output abbreviations of the parameter names in the output mode to replace the full names of the parameters only if they can unambiguously determine the meaning of the parameters according to the abbreviation of the parameter names.

For the flashlight provided in the present embodiment, after the input module inputs the first input information, the first main control module determines output mode of the flashlight according to the first input information, and generates the corresponding first control instruction. The display outputs the flashlight parameters and the parameter names according to the first control instruction. Since the flashlight provided in the present invention may display not only the values of parameters and but also their names, users may be able to directly understand the meaning of the parameters according to the parameter names without having to view the specification, which will further facilitate the widespread use of flashlight.

Besides, for the flashlight provided in the present embodiment, after the input module inputs the second input information, the first main control module may determine the display mode of the flashlight according to the second input information, and generate the corresponding second control instruction. The display may output the display language and color of the flashlight parameters according to the second control instruction. Since the flashlight provided in the present embodiment can adopt various languages to display the paramaters, it can readily be used by users in different countries and expand the application and scope of flashlights. Moreover, different display zones may display different colors, which will enrich the color of the display interface of the flashlight.

Each embodiment of the present invention is described in a progressive manner, with the focus of each embodiment different from all other embodiments, and the identical portion between different embodiments may be referred to each other. With the above description of the disclosed embodiments, persons skilled in the art will be able to realize or use the present invention. Furthermore, various modifications to those embodiments will become apparent to persons skilled in the art. The general principle defined herein may be realized in other embodiments without departing from the spirit or scope of the present invention. Therefore, the present invention will not be limited to those embodiments as illustrated herein, but should be in accordance with the broadest scope having the same principle and novel characteristics as disclosed in the present invention.

We claim:

1. A flashlight, comprising:
an input module, configured to receive a first input information, wherein the first input information is used to trigger a first main control module to adjust an output mode of the flashlight; wherein the output mode is an output mode comprising a flashlight parameters and a parameter names;
the first main control module connected to the input module, configured to receive the first input information, determine the output mode of the flashlight corresponding to the first input information, and generate the first main control instruction corresponding to the output mode;
a display connected to the first main control module, configured to receive the first main control instruction, and output the flashlight parameters and the parameter names according to the first main control instruction.

2. The flashlight of claim 1, wherein the input module is further configured to receive a second input information; wherein the second input information is used to trigger the first main control module to adjust a display mode of the flashlight; wherein the display mode comprises a configured display language and a number of colors of choice in displaying the flashlight parameters;
the first main control module is further used to receive the second input information, adjust the display mode of the flashlight corresponding to the second input information, and generate a second control instruction corresponding to the display mode;
the display is further used to receive the second control instruction, and output display language and color of the flashlight parameters according to the second control instruction, wherein the display is a color liquid crystal display.

3. The flashlight of claim 2, wherein the parameters comprise a flashing mode, a power, a flashing time, a focal length and a frequency; wherein the flashing mode comprises a Through the Lens (TTL) mode, a manual mode, a repetition mode, a wireless mode and a custom mode.

4. The flashlight of claim 1, further comprising:
a stepper motor, a voltage-stabilizing circuit and a voltage boosting and stabilizing charging circuit connected to the first main control module.

5. The flashlight of claim 4, further comprising:
a power source connected to the voltage-stabilizing circuit, the voltage boosting and stabilizing charging circuit and the first main control module.

6. The flashlight of claim 5, further comprising:
a capacitor connected to the first main control module and the voltage boosting and stabilizing charging circuit.

7. The flashlight of claim 6, further comprising:
a second main control module connected to the first main control module.

8. The flashlight of claim 7, wherein the first main control module and the second main control module are connected via a synchronous/asynchronous serial receiver/transmitter.

9. The flashlight of claim 8, further comprising:
a wireless instruction receiving module, a camera hot shoe connector, a light sensor module and a trigger circuit connected to the second main control module; wherein the trigger circuit is connected to the flashlight tube for controlling an on or off function of the flashlight tube.

10. The flashlight of claim 9, further comprising:
a high temperature monitoring module connected to the first main control module, and a buzzer alarm module connected to the second main control module.
